(19) United States
(12) Patent Application Publication
(10) Pub. No.: US 2025/0305765 A1
(43) Pub. Date: Oct. 2, 2025

(54) TREATMENT FACILITY FOR TREATING WORKPIECES, AND METHOD FOR TREATING WORKPIECES

(71) Applicant: Dürr Systems AG, Bietigheim-Bissingen (DE)

(72) Inventors: Oliver IGLAUER-ANGRIK, Stuttgart (DE); Kevin WOLL, Heilbronn (DE)

(21) Appl. No.: 18/850,999

(22) PCT Filed: May 23, 2023
(86) PCT No.: PCT/DE2023/100375

§ 371 Date: Sep. 25, 2024

(30) Foreign Application Priority Data
May 24, 2022 (DE) 10 2022 113 076.2

(51) Int. Cl. F26B 21/04; F26B 3/04; F26B 15/12; F26B 23/06

(52) U.S. Cl. CPC F26B 21/04; F26B 3/04; F26B 15/12; F26B 23/06; F26B 2210/12

(57) ABSTRACT

The present invention relates to a treatment plant (100) for treating workpieces (102), in particular for drying vehicle bodies, which comprises a treatment space (107) for receiving and treating one or more workpieces (102), wherein the treatment space (107) comprises a plurality of treatment space portions (108) which are each assigned to a separate recirculated air unit (118) by means of which a recirculated air flow guided through the respective treatment space portion (108) in a flow direction can be generated, wherein the treatment space (107) has a conveying direction (114) through the treatment space portions (108) and a transverse direction (115) of the treatment space (107) running perpendicular to the conveying direction (114), and wherein each recirculated air unit (118) comprises the following: —a fan (120) for driving the recirculated air flow in the respective recirculated air unit (118); —one or more temperature-control apparatuses (122) for heating or cooling the recirculated air flow; —one or more supply apparatuses (126) and/or supply modules (127) for supplying the recirculated air flow to the treatment space portion (108); —one or more supply ducts (142) for supplying the recirculated air flow to the one or more supply apparatuses (126) and/or supply modules (127); —one or more return ducts (128) for returning the recirculated air flow from the treatment space portion (108) to the fan (120); and —one or more electrical auxiliary temperature-control apparatuses (152) for reheating or recooling the recirculated air flow in the supply ducts (142) and/or return ducts (128).

### RELATED APPLICATION

This application is a national phase of international application No. PCT/DE2023/100375 filed on May 23, 2023, and claims the benefit of German application No. 10 2022 113 076.2 filed on May 24, 2022, which are incorporated herein by reference in their entirety and for all purposes.

### FIELD OF DISCLOSURE

The present disclosure relates to a treatment plant for treating workpieces, in particular for drying vehicle bodies. The treatment plant is thus in particular a constituent part of a painting plant for painting vehicle bodies. The disclosure also relates to a corresponding method for treating workpieces.

### BACKGROUND

Dryers have hitherto usually been heated in a centralized manner. For this, in particular burner systems, gas turbines or other gas-heated plants are suitable. For gas-heated plants, the central heating is often the concept of choice owing to the flexibility, controllability, preassembly of the fan units and savings in current consumption, but the setting up of external supply units and their connection via gas ducts can also entail disadvantages.

### SUMMARY

The present disclosure is based on the object of providing a treatment plant which is of simple and compact construction and enables efficient operation.

This object is achieved according to examples disclosed herein by means of a treatment plant having the features as claimed in claim 1.

The treatment plant is used to treat workpieces. In particular, the treatment plant is a dryer for drying vehicle bodies.

The treatment plant preferably comprises the following:

a treatment space for receiving and treating one or more workpieces, wherein the treatment space comprises a plurality of treatment space portions which are each assigned to a separate recirculated air unit by means of which a recirculated air flow guided through the respective treatment space portion in a flow direction can be generated.

Preferably, the treatment space has a conveying direction through the treatment space portions and a transverse direction of the treatment space running perpendicular to the conveying direction.

Each recirculated air unit comprises the following:
a fan for driving the recirculated air flow in the respective recirculated air unit;
one or more temperature-control apparatuses for heating or cooling the recirculated air flow;
one or more supply apparatuses and/or supply modules for supplying the recirculated air flow to the respective treatment space portion;
one or more supply ducts for supplying the recirculated air flow to the one or more supply apparatuses and/or supply modules;
one or more return ducts for returning the recirculated air flow from the treatment space portion to the fan.

Due to the fact that the treatment plant preferably comprises one or more recirculated air units, the treatment plant can preferably be of simple and compact construction.

Provision may be made for each recirculated air unit to further comprise the following: one or more electrical auxiliary temperature-control apparatuses for reheating or recooling the recirculated air flow in the one or more supply ducts and/or the one or more return ducts.

The treatment plant preferably comprises a plurality of temperature-control apparatuses which are used in particular to heat or cool different treatment space portions. The treatment plant thus preferably comprises a decentralized system for adjusting the temperature. This preferably makes it possible for the interfaces and thus the complexity in engineering and on the construction site to be minimized.

It may be advantageous for the one or more temperature-control apparatuses to be electrically operated or gas-operated temperature-control apparatuses.

In the case of gas-operated temperature-control apparatuses, a centralized or decentralized clean gas heating system is preferably provided. In this case, the heat energy contained in a clean gas is transferred to the recirculated air of the recirculated air units, wherein the clean gas is preferably provided by a thermal exhaust gas purification plant (TAR). In the case of centralized clean gas heating, the heat is transferred by a central heat exchanger of the treatment plant, whereas in the case of decentralized clean gas heating, a corresponding clean gas heat exchanger is provided in each recirculated air unit. It should be understood that the central heat exchanger forms the temperature-control apparatus of each recirculated air unit in the case of a centralized clean gas heating system.

A gas-operated temperature-control apparatus may alternatively also be formed by a single gas burner, with the result that each recirculated air unit is heated in a decentralized manner by a respective single burner.

In the case of electrically operated temperature-control apparatuses, provision may be made for the required heat energy to be provided in a centralized manner by a purely electrically operated, in particular flameless, regenerative thermal oxidation apparatus (F-RTO) or for the temperature-control apparatuses to each comprise one or more electrical heating registers in a decentralized manner for heating the recirculated air. In particular, by way of the latter, the temperature-control apparatuses can preferably be rapidly controllable and have a low pressure loss. Furthermore, in comparison to a centralized gas-operated treatment plant, complex duct systems can be saved in the case of decentralized electrically operated temperature-control apparatuses.

By means of the one or more supply apparatuses and/or supply modules, the recirculated air can be routed or streamed in a targeted or directed manner to certain regions of the workpiece to be treated, wherein the supply apparatuses can be in the form of a supply nozzle.

One or more supply ducts may, for example, fluidically connect a distributor space, arranged directly downstream of the temperature-control apparatus, to the supply apparatuses or to the supply modules.

Provision may also be made for one or more supply ducts to for example fluidically connect a distributor space, arranged directly downstream of the temperature-control apparatus, to one or more supply modules which are arranged below, above or to the side of the workpiece, i.e. in particular the vehicle body. In this way, it is in particular possible for a targeted incident flow of recirculated air to be applied to sill regions or other high-mass parts of the workpieces.

It is particularly advantageous for one or more electrical auxiliary temperature-control apparatuses for reheating or recooling the recirculated air flow to be arranged in the one or more supply ducts and/or the one or more return ducts. This makes it possible in particular to generate an additionally heated or cooled partial volume flow of the recirculated air flow and supply it to the treatment space portion, in particular route it to the workpieces.

It may be advantageous for partial volume flows of the recirculated air flow to be heatable by means of the one or more auxiliary temperature-control apparatuses and to be routable in a targeted manner by means of supply apparatuses and/or supply modules to those portions of the workpiece to be treated which have an increased heat demand for carrying out the treatment operation.

It may be particularly advantageous for the one or more temperature-control apparatuses or the electrical auxiliary temperature-control apparatuses to be the only apparatuses which are in particular used primarily for heating the recirculated air flow.

It may be advantageous for the treatment space to comprise a conveying apparatus by means of which one or more workpieces can be conveyed on a receiving unit in the conveying direction through the treatment space portions of the treatment space.

The treatment space portions are preferably arranged one after the other along the conveying direction of the conveying apparatus of the treatment plant.

The workpieces can preferably be conveyed in a transverse orientation through the treatment space, wherein, in the transverse orientation, a longitudinal axis, in particular vehicle longitudinal axis, of the workpieces is oriented transversely, in particular at least approximately perpendicularly, to the conveying direction and/or at least approximately horizontally.

It is also conceivable for the workpieces, i.e. in particular the vehicle bodies, to be conveyed in the direction of their longitudinal axis.

The conveying apparatus preferably comprises two rail units which extend through the treatment space portions and on which a receiving unit which receives at least one workpiece during the treatment can be moved in the conveying direction.

By means of the fan, the recirculated air flow can preferably be driven in such a way that it flows successively in the flow direction through, inter alia, the temperature-control apparatus, a distributor space, one or more supply ducts, one or more supply apparatuses and/or supply modules, a treatment space portion of the treatment space, one or more return ducts and an intake space, in particular in this order, before it passes to the fan again.

The temperature-control apparatus is preferably a heating apparatus for heating the recirculated air flow. However, it is also conceivable for this to be a cooling apparatus for cooling the recirculated air flow. It is furthermore also conceivable for the temperature-control apparatus to be able to selectively perform heating or cooling.

The one or more temperature-control apparatuses are preferably arranged downstream of the fan and/or upstream of a distributor space. The distributor space preferably adjoins the treatment space and serves to distribute the recirculated air flow to the one or more supply ducts.

It may be advantageous for an intake space to be provided upstream of the fan.

It may be favorable for the intake space to be arranged between the treatment space portion and the fan, in particular in relation to the transverse direction of the treatment space.

As an alternative or in addition thereto, provision may be made for the intake space to be arranged in the vertical direction at least approximately at the same height as an impeller of the fan.

In a further embodiment of examples disclosed herein, provision may be made for an ejection region and/or a homogenization region to be provided downstream of the fan.

It may be advantageous for the ejection region and/or the homogenization region to be arranged directly above the fan and/or an intake space.

As an alternative or in addition thereto, provision may be made for the ejection region and/or the homogenization region to be arranged in the horizontal direction at least approximately at the same height as the one or more temperature-control apparatuses.

Provision is preferably made for the fan to be a radial fan, wherein an axis of rotation of an impeller of the radial fan is oriented at least approximately horizontally and/or at least approximately perpendicularly to the conveying direction of the treatment space.

Provision may be made for at least one supply module within the treatment space portion to be arranged below the receiving unit and/or horizontally at least approximately at the same height as the conveying apparatus.

At least one supply module is preferably arranged between the rail units of the conveying apparatus.

As an alternative or in addition thereto, provision may be made for at least one supply module to be arranged on that side of the treatment space portion which is opposite the fan.

As an alternative or in addition thereto, provision may also be made for at least one supply module to be arranged above the one or more workpieces.

The respective treatment space portion is preferably surrounded by a housing which is open at the side surfaces, through which the conveying apparatus extends. The at least one supply module may then be arranged on the top surface of the housing, above the workpieces conveyed through the treatment space portion, in order to supply part of the recirculated air flow to the workpieces from above.

Provision may be made for a supply module to comprise one or more supply portions, and for a supply portion to in each case comprise at least one, preferably at least two nozzles.

In one embodiment of examples disclosed herein, provision may be made for the one or more supply portions to comprise a plurality of nozzles which are arranged within the respective supply portion parallel and/or transversely to the conveying direction.

It may be advantageous for the nozzles to be arranged in a row within the respective supply portion.

In one embodiment of examples disclosed herein, provision may be made for an arrangement and/or orientation of the at least one nozzle within the respective supply portion to be able to be adapted to the one or more workpieces to be treated.

This makes it possible to orient the nozzles onto those portions of the workpiece to be treated which have an increased recirculated air flow demand. It is conceivable for there to be exchangeable nozzle arrangements for the respective supply portion of a supply module, and/or for use to for example be made of perforated sheets which can be used to vary the position and/or size of the outlet openings of the nozzles.

It may be favorable for the recirculated air flowing through the nozzles of the supply portions to able to be supplied directly, in particular unimpeded, to at least part of the one or more workpieces.

This prevents part of the recirculated air flow from for example transferring heat to the receiving unit on which the workpiece is conveyed.

In one embodiment of examples disclosed herein, provision may be made for the one or more return ducts to run below the treatment space portion, in particular in a bottom wall which downwardly delimits the respective treatment space portion.

Provision may preferably also be made for each recirculated air unit to comprise at least one throttle for retarding the recirculated air flow in certain portions and/or at least one auxiliary fan for accelerating the recirculated air flow in certain portions.

The at least one throttle and/or the at least one auxiliary fan may advantageously be arranged within the supply ducts, in order to adapt the speed of the recirculated air partial flows flowing out into the treatment space portion.

In one embodiment of examples disclosed herein, provision may be made for one or more filter elements for filtering the recirculated air to be arranged within the distributor space.

This ensures that no dirt particles and/or solvents, which are returned from the treatment space portion, are supplied back to the workpiece.

It may be favorable for the one or more recirculated air units, in particular all the recirculated air units, to be arranged laterally adjoining the respective treatment space portion. In particular, a framework for elevated assembly is then preferably unnecessary.

Preferably, the one or more recirculated air units are completely accessible at ground level, in particular for assembly and/or maintenance work.

The treatment plant then preferably does not require a complex framework structure.

Examples disclosed herein are also based on the object of providing a method which, using a treatment plant of simple and compact construction, enables efficient operation of same.

This object is achieved according to examples disclosed herein by means of a method as claimed in the independent method claim.

The method is in particular a method for treating workpieces, in particular for drying vehicle bodies.

The method preferably comprises the following:

supplying one or more workpieces to a treatment space of a treatment plant, in particular a treatment plant according to examples disclosed herein;
heating the one or more workpieces by means of one or more recirculated air flows,
wherein the one or more recirculated air flows are generated by means of one or more recirculated air units.

Optionally, the method further comprises the following:

heating or cooling the one or more recirculated air flows by means of one or more electrical temperature-control apparatuses and/or one or more auxiliary temperature-control apparatuses.

The method preferably has one or more of the features and/or advantages described in connection with the treatment plant.

The treatment plant preferably also has one or more of the features and/or advantages described in connection with the method.

It may be favorable for conditioned fresh air to be supplied to the treatment space and this fresh air to subsequently be recirculated as recirculated air flow in one or more recirculated air units, wherein heat or cold is supplied in the recirculated air units exclusively by electrical temperature control.

The conditioned fresh air is in particular supplied via one or two locks at one or both ends of the treatment space.

The treatment plant preferably further comprises a discharge apparatus for discharging exhaust air. The exhaust air is in particular discharged from a treatment space portion which is for example arranged centrally with respect to the conveying direction.

It may be advantageous for the exhaust air to be supplied to a cleaning apparatus, for example a regenerative thermal oxidation apparatus (RTO), in order to remove contaminants contained in the exhaust air. The cleaning apparatus is preferably arranged outside a building in which the treatment plant is constructed.

In one embodiment of examples disclosed herein, provision may be made for the one or more recirculated air flows to be supplied in an at least approximately horizontal direction to one or more fans of the one or more recirculated air units.

As an alternative or in addition thereto, provision may be made for the one or more recirculated air flows to be discharged in an at least approximately vertical direction upward from the one or more fans.

Furthermore, as an alternative or in addition thereto, provision may be made for the one or more recirculated air flows to be deflected in a space region arranged above the one or more fans and/or to be supplied, in particular in an at least approximately horizontal direction, to the one or more electrical heating apparatuses.

It may be favorable for the recirculated air flow to be divided into a plurality of partial volume flows downstream of a temperature-control apparatus forming the main temperature-control apparatus and for one or more of the partial volume flows to be additionally heated or cooled by means of one or more auxiliary temperature-control apparatuses.

Both the main temperature-control apparatus and the one or more auxiliary temperature-control apparatuses are preferably electrical apparatuses, for example electrical heating registers.

The treatment plant and/or the method may preferably also have one or more of the features and/or advantages described below:

Provision may optionally be made for one or more guiding elements for targeted flow guidance and/or flow influence to be arranged in a space region which directly adjoins a fan and opens out in particular into a temperature-control apparatus.

By means of one or more guiding elements, at least approximately homogeneous incident flow of the temperature-control apparatus can preferably be obtained.

Furthermore, as an alternative or in addition, one or more covering elements may be provided, which partially cover an incident-flow cross-sectional area of the temperature-control apparatus. This can also serve for a more homogeneous flow.

One or more covering elements may, for example, be in the form of a perforated sheet in order to effect local throttling of the flow.

The one or more covering elements are thus preferably throttle elements.

It may be favorable for the one or more temperature-control apparatuses, in particular heating registers, to be dimensioned in such a way that they can be removed in a direction running at least approximately parallel to the conveying direction from a receptacle for the respective temperature-control apparatus, in particular without the need to dismantle other components of the treatment plant.

Provision may for example be made for each recirculated air unit to be assigned to a plurality of treatment space portions but to extend only over one of the treatment space portions, such that one or more adjacently arranged treatment space portions proceeding from the temperature-control apparatus along the conveying direction enable a free space for maintenance and/or repair of the temperature-control apparatus.

In particular, one or more electrical heating registers are dimensioned such that their insertion depth falls short of an extent of a treatment space along the conveying direction.

The arrangement of the temperature-control apparatuses is in particular selected such that, next to each temperature-control apparatus, at least one adjacent treatment space portion is not occupied by a temperature-control apparatus. The disassembly can then be effected in or counter to the conveying direction (running direction through the dryer). This preferably reduces a required reserved space extending perpendicularly to the conveying direction onto the disassembly space of the fan.

To recover heat discharged by way of the exhaust air, heat exchangers may for example be provided. These transfer the heat for example to a fresh air flow to be supplied. In particular, this preferably makes it possible to partially preheat the fresh air flow.

As an alternative thereto, heat may preferably be recovered by way of waste heat boilers.

The one or more recirculated air units can preferably be preassembled together with the assigned one treatment space portion or together with the assigned plurality of treatment space portions and can be transported as a unit to a final assembly location. Media interfaces can preferably be omitted in this way; only a power connection is then required.

Preferably, one or more, in particular all, of the electrically operated heating components, such as inter alia the electrically operated auxiliary temperature-control apparatus, the F-RTO, or the heating register, can be supplied with a mean voltage of for example at least approximately 3 kV and/or at most approximately 8 kV, in particular 4160 V to 6600 V, instead of the customary 400 V. This may indeed require special heating elements with corresponding additional costs, but preferably offers large saving potential in the periphery, i.e. with respect to the connections, cables, etc. Furthermore, a substantially lower factor of the voltage transformation from the supply network is required, this inter alia reducing the size of the transformer station to the benefit of lower capital costs and saving space. The connection to an electrically operated heating component with such a mean voltage also entails considerably lower cable diameters.

Further preferred features and/or advantages of examples disclosed herein are the subject of the description below and of the diagrammatic illustration of exemplary embodiments.

### BRIEF DESCRIPTION OF THE DRAWINGS

FIG. 1 shows a schematic vertical cross section through a first embodiment of a treatment plant;

FIG. 2 shows a schematic vertical partial cross section of an isometric illustration of the first embodiment of the treatment plant;

FIG. 3 shows a schematic horizontal cross section of the first embodiment of the treatment plant;

FIG. 4 shows a schematic vertical cross section through a second embodiment of the treatment plant;

FIG. 5 shows a schematic vertical partial cross section of an isometric illustration of the second embodiment of the treatment plant;

FIG. 6 shows a schematic partial view of an isometric illustration of a third embodiment of the treatment plant;

FIG. 7 shows a schematic partial view of an isometric illustration of a treatment space portion of a fourth embodiment of the treatment plant;

FIG. 8 shows a further schematic partial view of an isometric illustration of a fifth embodiment of the treatment plant;

FIG. 9 shows a schematic partial view of an isometric illustration of a sixth embodiment of the treatment plant;

FIG. 10 shows a schematic vertical cross section through the sixth embodiment of the treatment plant; and

FIG. 11 shows a schematic horizontal longitudinal section through the sixth embodiment of the treatment plant.

Identical or functionally equivalent elements are provided with the same reference signs in all of the figures.

### DETAILED DESCRIPTION OF THE DRAWINGS

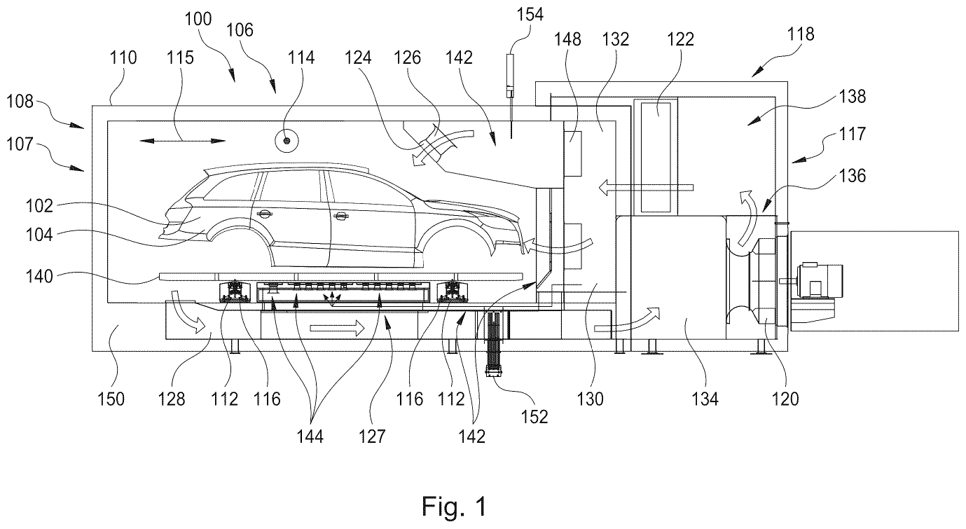

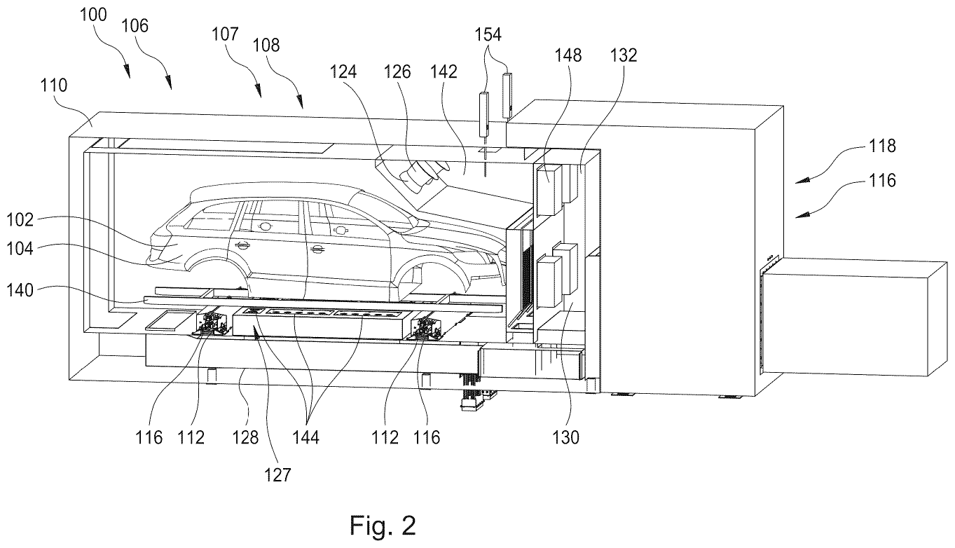

A first embodiment, illustrated in FIGS. 1 and 2, of a treatment plant denoted as a whole by 100 serves for the treatment of workpieces 102, in particular vehicle bodies 104. The treatment plant 100 is in particular a dryer 106 for drying precoated vehicle bodies 104.

The treatment plant 100 comprises a treatment space 107 which serves to receive workpieces 102 for treatment of same.

The treatment space 107 comprises a plurality of treatment space portions 108.

A housing 110 surrounds a treatment space portion 108.

The workpieces 102 can in particular be conveyed by means of a conveying apparatus 112 of the treatment plant 100 along a conveying direction 114 through the treatment space 107, i.e. through the treatment space portions 108, and can have recirculated air applied to them in the process. The treatment space 107 preferably has a transverse direction 115 running perpendicular to the conveying direction.

As illustrated, the conveying apparatus 112 may comprise two rail elements 116.

The treatment plant 100 comprises an air guide system 117 which in particular comprises one or more recirculated air units 118. By means of the one or more recirculated air units 118, a recirculated air volume flow can be guided repeatedly through the respective treatment space portion 108.

Each recirculated air unit 118 preferably comprises a fan 120 for driving the recirculated air flow, a temperature-control apparatus 122 for heating or cooling the recirculated air flow, one or more supply apparatuses 126 in the form for example of supply nozzles 124 and one or more supply modules 127 for supplying the recirculated air flow to the treatment space portion 108, and one or more return ducts 128 for discharging the recirculated air flow from the treatment space portion 108.

Arranged between the temperature-control apparatus 122 and the one or more supply apparatuses 126 is preferably a distributor space 130 which serves to distribute the heated recirculated air flow to the supply apparatuses 126 and/or supply modules 127. The distributor space 130 is preferably accessible for people and also serves as a maintenance region 132 for carrying out cleaning and/or maintenance work within the respective recirculated air unit 118.

The fan 120 is preferably a freely running plug fan.

The fan 120 is preferably a radial fan. However, as an alternative thereto, in an embodiment that is not illustrated, provision may also be made for the fan 120 to be a longitudinal flow fan (axial fan).

Provided upstream of the fan 120 is preferably an intake space 134 which extends in particular transversely, preferably perpendicularly, to the conveying direction 114 over a depth which corresponds at least approximately to a diameter of an impeller of the fan 120. In this way, efficient intake is possible perpendicular to the conveying direction 114.

The intake space 134 is preferably arranged between the treatment space 110 and the fan 120, in particular in the transverse direction 115 of the treatment space 107.

An ejection region 136 of the fan 120 is preferably formed above the fan 120. The fan 120 thus preferably effects its intake action in the horizontal direction and its ejection action upward in the vertical direction.

The ejection region 136 is preferably followed by a homogenization region 138 which serves to supply the recirculated air flow to the temperature-control apparatus 122 as homogeneously as possible.

The workpiece 102 is received by a receiving unit 140 which can be moved or conveyed on the rail elements 116 of the conveying apparatus 112 in the conveying direction 114.

After passing through the temperature-control apparatus 122, the recirculated air is guided through one or more supply ducts 142 to the supply apparatuses 126 and/or the supply modules 127.

The supply module comprises a plurality of supply portions 144.

A supply portion 144 comprises at least one nozzle 146.

One or more filter elements 148 are preferably arranged downstream of the temperature-control apparatus 122, in particular in the distributor space 130 or subsequent thereto, for example directly upstream of the one or more supply apparatuses 126 and/or the one or more supply modules 127. The one or more filter elements 148 serve in particular to separate contaminants from the recirculated air flow before the latter is supplied to the treatment space 107 or treatment space portion 108.

The one or more return ducts 128 are for example arranged, in particular integrated, in a bottom wall 150 of the housing 108 of the treatment space portion 107. Preferably, the one or more return ducts 128 extend over more than half of a width of the treatment space, i.e. in particular in the transverse direction 115.

The first embodiment of a treatment plant 100 illustrated in FIGS. 1 and 2 functions as follows:

First, one or more workpieces 102 are introduced into the treatment space 107 in the conveying direction 114 by means of the conveying apparatus 112. Heated or cooled recirculated air from the one or more recirculated air units 118 is then applied to the workpieces 102 and for example dries them as a result.

For this purpose, the recirculated air is circulated by means of the fan 120 and thus flows, proceeding from the fan 120, successively through the ejection region 134, the homogenization region 138, the temperature-control apparatus 122, the distributor space 130, optionally one or more filter elements 148, the one or more supply apparatuses 126 and/or supply modules 127, the treatment space portion 108 and the one or more return ducts 128. Lastly, the recirculated air passes via the intake space 134 back to the fan 120.

For example, the heat required for carrying out the treatment operation is generated by means of the temperature-control apparatus 122. To this end, the temperature-control apparatus 122 is or comprises an electrical heating register which when flowed through releases electrically generated heat to the recirculated air flow.

The temperature-control apparatus 122 thus generates the heat where it is required. An additional other heat source which is arranged outside the respective recirculated air unit 118 and thus takes up space is therefore preferably unnecessary. In this way, the recirculated air unit 118 can be of particularly compact design. In particular, complex conduits for heating gas or other heat transfer media are unnecessary.

Provision may be made for each recirculated air unit 118 to comprise a single temperature-control apparatus 122.

As an alternative thereto, provision may be made for each recirculated air unit 118 to comprise a plurality of temperature-control apparatuses 122, wherein one temperature-control apparatus 122 is then preferably a main temperature-control apparatus assisted by one or more auxiliary temperature-control apparatuses 152 which is or are preferably operated electrically.

The main temperature-control apparatus 122 is in this case the one arranged between the distributor space 130 and the fan 120.

The auxiliary temperature-control apparatuses 152 are arranged in or on the supply ducts 142 in order to reheat or recool part of the recirculated air flow.

In the first exemplary embodiment illustrated in FIGS. 1 and 2, the electrical auxiliary temperature-control apparatuses 152 are connected to the bottom wall 150. The auxiliary temperature-control apparatuses 152 are preferably resistance heating apparatuses, the heating rods of which project into the supply duct 142 which guides the recirculated air to the supply module 127. In this way, additional heat is transferred to that proportion of the recirculated air flow which flows in an incident manner on the bottom side of the workpiece 102, preferably on the sill regions.

The temperature-control apparatuses 122, 152 may alternatively also be in the form of a cooling apparatus, in particular in the form of Peltier elements or cold water registers, in order to cool the recirculated air flow. This is advantageous in particular for the treatment space portions 108 which are arranged in the conveying direction 114 at the end of the treatment space 107.

The recirculated air unit 118 may further comprise one or more temperature sensors 154 which preferably measure the temperature in the supply ducts 142.

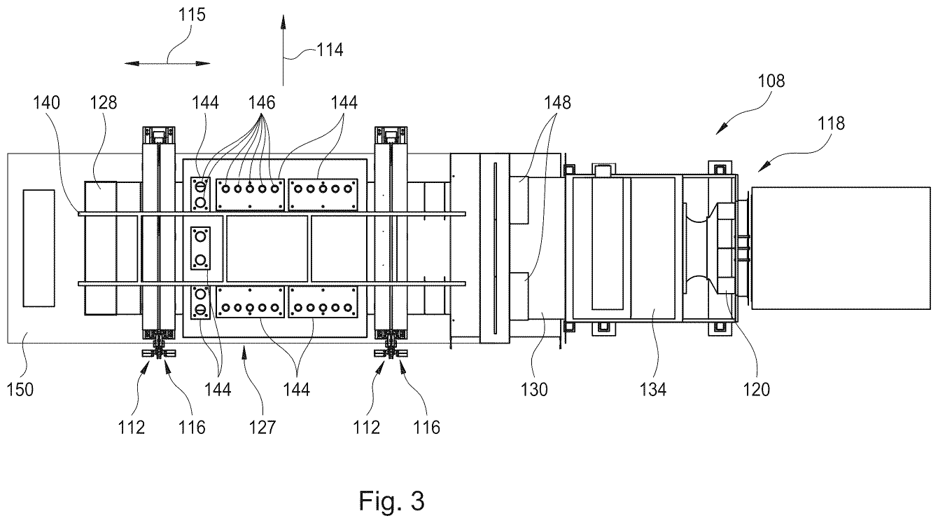

The arrangement of the supply portions 144 or the nozzles 146 thereof in the supply module 127 of the treatment space portion 108 shown in FIGS. 1 and 2 is apparent in FIG. 3.

The supply module 127 arranged between the two rail elements 116 of the conveying apparatus 112 comprises four supply portions 144 whose five nozzles 146 are in each case arranged in the transverse direction 115 and three supply portions 144 whose two nozzles 146 are in each case arranged in the conveying direction 114.

The supply portions 144 are positioned such that the outflowing recirculated air in the direction of the workpiece 102 is not impeded by or has to flow around the receiving unit 140.

In the first exemplary embodiment illustrated in FIG. 3, the nozzles 146 of the supply portions 144 are arranged such that an incident flow is applied in particular to the sill regions of vehicle bodies 104.

It is conceivable that the supply portions 144 can be rapidly and simply exchanged, with the result that the supply module 127 can be easily adapted to workpieces to be treated.

Advantageously, the supply portions 144 can differ in terms of the number, dimensions and orientation of the nozzles 146.

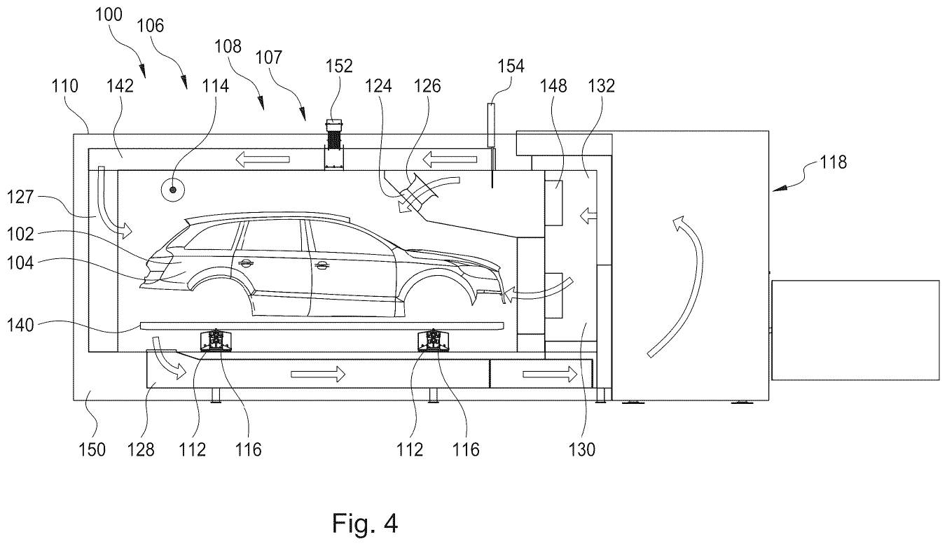

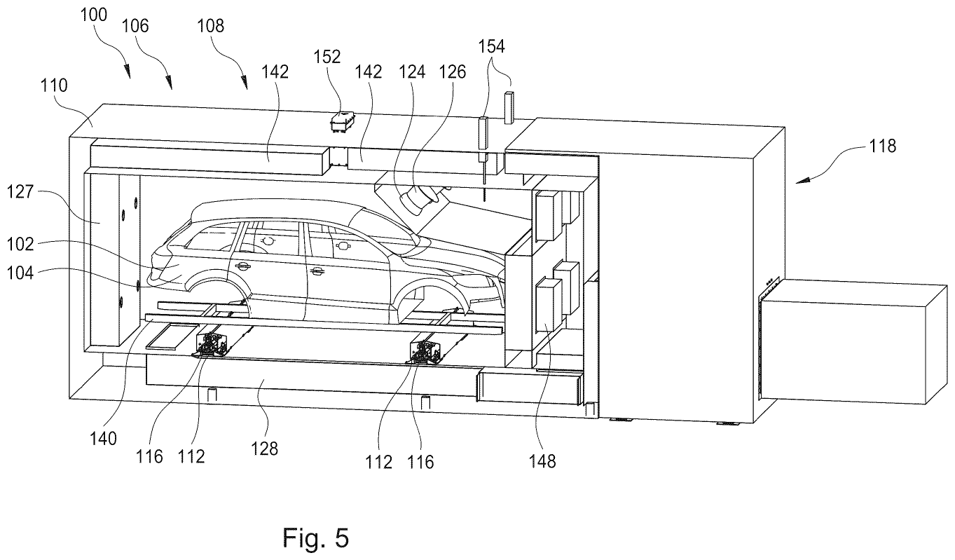

FIGS. 4 and 5 illustrate a second embodiment of a treatment plant according to examples disclosed herein.

In the second embodiment, the supply module 127 is arranged on that side of the treatment space portion 108 which is opposite the fan 120 or the distributor space 130.

The proportion of recirculated air supplied to the supply module 127 is supplied via the supply duct 142, which is arranged running in the transverse direction 115 on the top surface of the housing 110.

An auxiliary temperature-control apparatus 152 heats or cools the recirculated air flow guided through the supply duct 142.

The supply module 127 shown in FIGS. 4 and 5 has a supply portion 144 which comprises four nozzles 146.

The nozzles 146 are oriented such that they apply an incident flow to the rear of the workpiece 102 which is illustrated in FIGS. 4 and 5 and is in the form of a vehicle body 104.

Also conceivable are embodiments of the treatment space portions 108 in which, for example, a supply module 127 is arranged on that side of the treatment space portion 108 which is opposite the distributor space 130 and between the rail elements 116 of the conveying apparatus 112, as a result of which, in the case of a workpiece 102 in the form of a vehicle body 104, an incident flow of the recirculated air is applied to both the rear region and the sill region and the front region of the vehicle body 104.

Depending on the extent of the treatment space portions 108 in the transverse direction 115, it may also be favorable for in each case more than one auxiliary temperature-control apparatus 152 and/or more than one temperature sensor 154 to be arranged along the supply ducts in order to ensure that the recirculated air guided through the corresponding supply apparatuses 126 and/or supply modules 127 has the correct temperature for that region of the workpiece 102 to be treated to which an incident flow is to be applied.

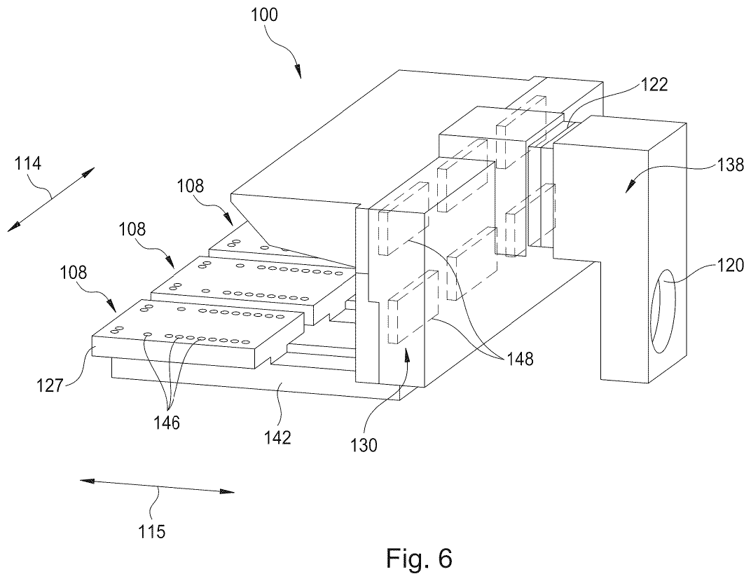

FIG. 6 illustrates a third embodiment of the treatment plant 100 in a schematic partial view.

FIG. 6 shows three treatment space portions 108 of a treatment space 107, which are arranged one behind the other in the conveying direction 114 and are supplied with recirculated air by a fan 120 via a temperature-control apparatus 122 and a common distributor space 130.

Only selected elements of the treatment space portions 108 are illustrated in order to be able to see that a respective supply duct 142 supplies recirculated air to the associated supply module 127 of a treatment space portion 108.

The supply duct 142 preferably extends in the transverse direction 115 and is arranged at least approximately centrally in the respective treatment space portion 108 in relation to the conveying direction 114.

The recirculated air supplied via the supply ducts 142 to the respective supply module 127 is routed from the distributor space 130 substantially through the respective lower filter elements 148 and is filtered therein.

The nozzles 146 of the supply modules 127 are preferably oriented onto the sill regions or other high-mass parts of the workpieces 102, in order to apply an incident flow of recirculated air thereto.

The width of the supply ducts 142 is preferably between 700 mm and 750 mm, further preferably between 725 mm and 745 mm, and particularly preferably 734 mm.

After it has been applied as an incident flow to the workpiece 102, the recirculated air in the respective treatment space portion 108 is returned via in each case two return ducts 128 (not illustrated in FIG. 6) to the intake space 134 (not illustrated in FIG. 6) and subsequently to the fan 120. This involves the suction removal of the recirculated air into the return ducts 128 preferably being effected on that side of the respective treatment space portion 108 which is opposite the filter elements 130 in the bottom region.

In relation to the conveying direction 114, one of the two return ducts 128 is arranged upstream of the supply duct 142 and the other of the two return ducts 128 is arranged downstream of the supply duct 142, wherein the return ducts 128 preferably contact the supply duct 142 or directly adjoin or butt against it.

The arrangement of a central supply duct 142 and two externally abutting return ducts 128 has the advantage that the total pressure loss of the recirculated air flow is lower than, for example, in the case of a reversed arrangement of a central return duct 128 and two externally abutting supply ducts 142. This advantage results in particular from the fact that the return ducts oriented substantially parallel to one another—similarly to in the case of an exhaust manifold of an internal combustion engine—are merged upstream of the intake space 134 of the fan 120.

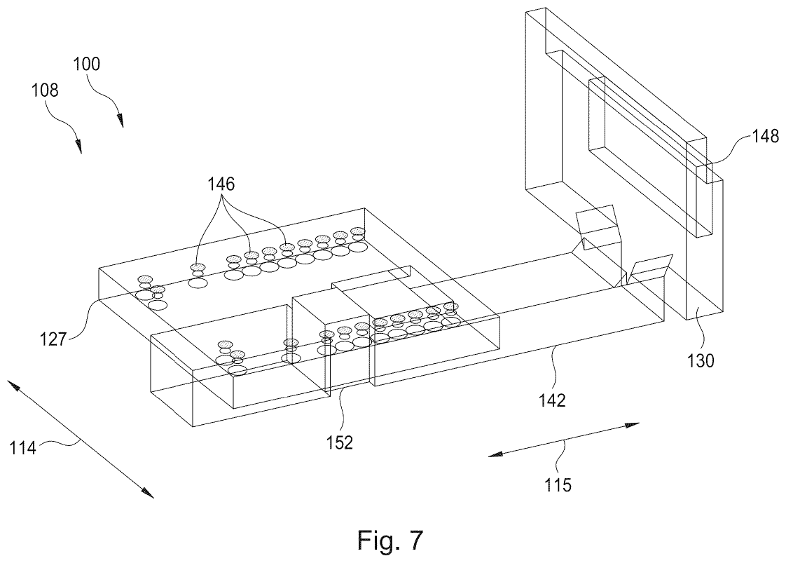

FIG. 7 illustrates a treatment space portion 108 of a fourth embodiment of the treatment plant 100 in a schematic partial view.

As an alternative or in addition to the third embodiment in FIG. 6, an auxiliary temperature-control apparatus 152 is arranged in the supply duct 142 and is preferably arranged below the supply module 127. In this way, the recirculated air supplied via the supply duct 142 is reheated or recooled in order to then be applied as an incident flow of reheated or recooled recirculated air, distributed via the nozzles 146, to the workpiece 102 arranged above the supply module 127.

Thus, a further advantage of a centrally arranged supply duct 142 is that the recirculated air supplied to the supply module 127 can be reheated or recooled using only one auxiliary temperature-control apparatus 152.

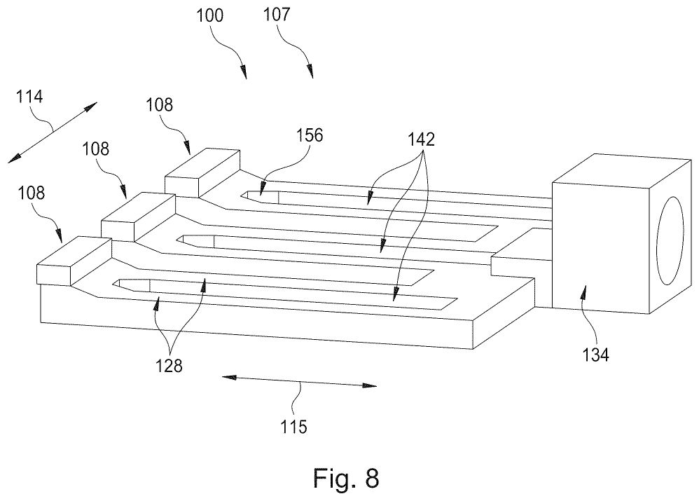

FIG. 8 illustrates a fifth embodiment of the treatment plant 100 in a schematic partial view, the illustration being reduced to the supply ducts 142, the return ducts 128 and a common intake space 134 of the fan 120.

The three central supply ducts 142 illustrated each have a beveled portion 156 at their end opposite the intake space 134.

In the beveled portion 156, the supply duct 142 is tapered, wherein both lateral walls of the supply duct 142 in the beveled portion 156 each enclose an angle preferably of 20° to 40°, further preferably of 25° to 35°, and particularly preferably of 30°, with the longitudinal axis of the supply duct 142.

The beveled portion 156 of the supply duct 142 has the effect that the pressure loss is reduced in the abutting return ducts 128 in the respective corresponding portions of the return ducts 128.

It should also be understood that a supply module 127 can be formed in different variants.

Preferably, for each treatment space portion 108, a supply module 127 is arranged between the two rail elements 116 of the conveying apparatus 112 of a treatment space 107, as is illustrated for example in FIGS. 1 to 3.

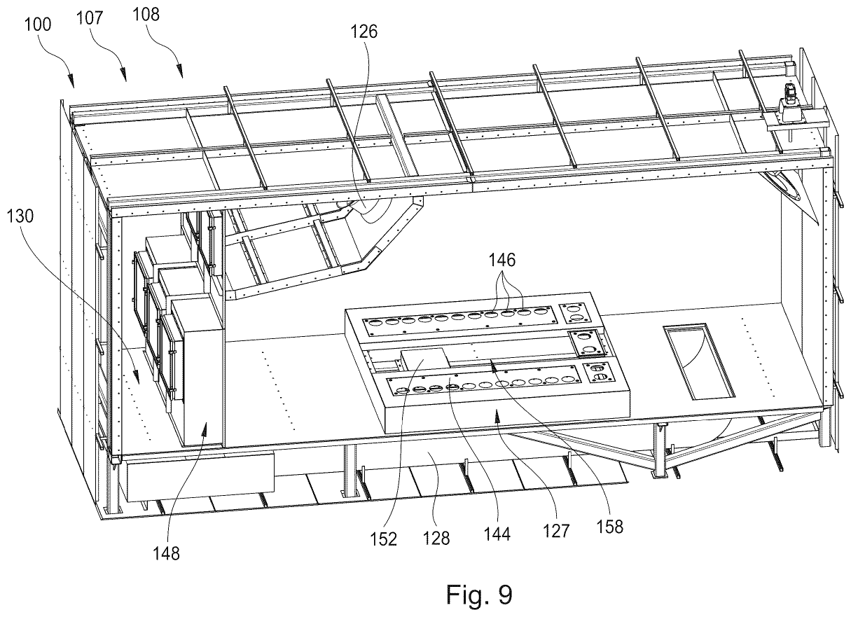

In terms of height, the respective supply module 127 is delimited by the receiving unit 140 on which in each case at least one workpiece 102 is received. In terms of width, i.e. in the transverse direction 115, the respective supply module 127 is delimited by the distance of the rail elements 116 of the conveying apparatus 112, and in terms of length, i.e. in the conveying direction 114, the respective supply module 127 preferably extends over the entire length of the respective treatment space portion 108, as apparent for example in FIGS. 3 and 9.

The supply module 127 can preferably be adapted to the workpiece or workpieces 102 to be treated, with the result that the supply module 127 in a first embodiment can be in the form of a pure bottom box without supply portions 144 and without nozzles 146.

The first embodiment of the supply module 127 lends itself particularly if the workpieces 102 are vehicle bodies 104 without their own bottom, such as for so-called electric vehicles with batteries in the bottom region. In this case, the supply module 127 in the form of a bottom box serves as a flow guide element for the internal flow in the vehicle body 104, which is generated by the supply nozzles 124 which cause the recirculated air to flow in via the windshield opening in the vehicle body 104.

In the first embodiment, i.e. in the form of a bottom box, the supply module 127 can either be in the form of a hollow body or simplified for the flow guidance also only in the form of an intermediate or guiding sheet above the bottom wall 150 of the respective treatment space portion 108.

In addition to the flow guidance property of the bottom box, provision may be made for the bottom box to be configured in such a way that the recirculated air can be supplied or returned via at least one of its surfaces.

In a second embodiment of the supply module 127, the supply module 127 comprises supply portions 144 with nozzles 146, as a result of which an incident flow can be applied from below in a targeted manner to high-mass parts of the workpieces 102 to be treated. In this case, the supply module 127 functions as a pressure space for the recirculated air feed of the nozzles 146.

The second embodiment of a supply module 127 can be seen for example in FIGS. 1 to 3. The suction removal or return of the recirculated air is effected, in relation to the vehicle body 104 oriented in the transverse direction 115, in the rear region of the vehicle body 104 and specifically outside the conveying apparatus 112, i.e. to the left from the left-hand rail element 116 of the conveying apparatus 112 in FIGS. 1 to 3.

The supply portions 144 and/or the nozzles 146 of a supply module 127 can preferably be freely arranged within the supply module 127, wherein an arrangement of the nozzles 146 in the transverse direction 115 along the sill regions of a workpiece 102 in the form of a vehicle body 104 is preferred. In addition thereto, it is advantageous for further nozzles 146 to be arranged oriented in the conveying direction 114 in the rear region of a workpiece 102 in the form of a vehicle body 104, since this region faces away from supply nozzles 124 in the front region of the workpiece 102 in the form of a vehicle body 104 and thus is in the flow shadow of the main flow.

The orientation of the nozzles 146 is preferably perpendicular to the floor assembly of a workpiece in the form of a vehicle body 104, i.e. in particular vertical. However, it is also conceivable for one or more nozzles 146 to have an angular position such that an incident flow can be applied to portions of the vehicle body 104 in the front and/or rear region that can otherwise not be reached directly.

The nozzles 146 are preferably arranged as close as possible to the workpiece 102 to be treated, and this achieves the effect that the supply module 127 has the maximum available height up to the receiving unit 140.

In the second embodiment, as illustrated in FIGS. 1 to 3, a supply module 127 is preferably used in a treatment space portion 108 which serves for the pre-drying and/or main drying, i.e. in a portion of the treatment space 107 in which the workpiece 102 to be treated has not yet reached maximum treatment temperature at the beginning.

Use of the second embodiment of a supply module 127 in a treatment space portion 108 which serves as so-called holding zone appears expedient if it is assumed that high-mass parts of the workpiece 102 to be treated have not yet been sufficiently heated and thus still constitute a heat sink.

An advantage of the second embodiment of a supply module 127 is that the supply portions 144 and/or the nozzles 146 can be easily exchanged and accordingly the incident-flow characteristics of the supply module 127 can be adapted in a simple manner to the workpiece 102 to be treated.

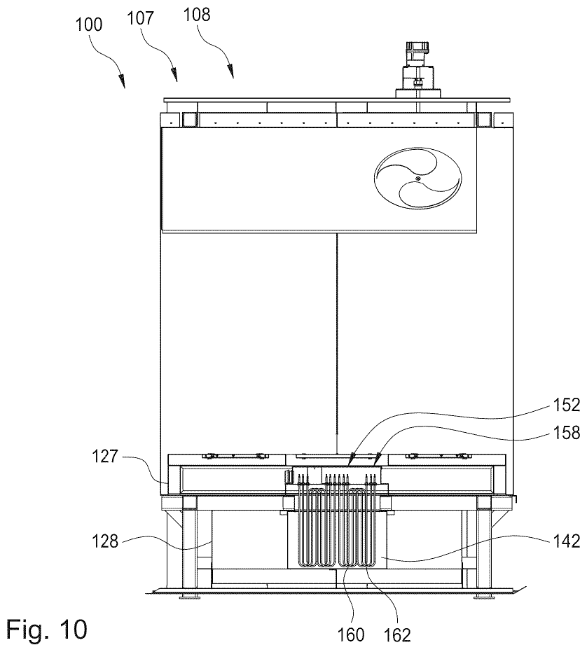

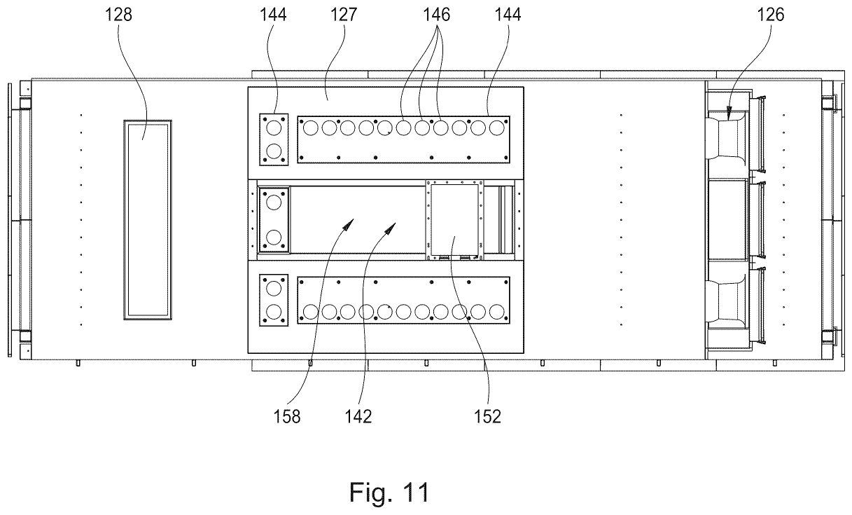

In a third embodiment of the supply module 127, which can be gathered from FIGS. 9 to 11, an auxiliary temperature-control apparatus 152, also called booster, is arranged in an inflow region 158 of the supply module 127.

FIGS. 9 to 11 depict part of a treatment space portion 108 of a treatment space 108 of a treatment plant 100.

The auxiliary temperature-control apparatus 152 in the supply module 127 preferably enables a temperature increase in the supplied recirculated air in the range from 5 K to 15 K and/or 15 K to 25 K and/or 25 K to 35 K.

What is sought is homogeneous heating of the workpiece 102 to be treated, which is preferably in the form of a vehicle body 104.

The auxiliary temperature-control apparatus 152 can preferably be activated and deactivated, as a result of which auxiliary temperature control can be selected depending on the workpiece 102 to be treated. The temperature of the auxiliary temperature-control apparatus 152 can also be adjusted, such that the auxiliary temperature control can be adapted to the workpiece 102 to be treated and/or to the treatment process in the respective treatment space portion 108.

The arrangement of the auxiliary temperature-control apparatus 152 in the inflow region 158 of the supply module 127 also enables precise temperature control through the shortened flow path between the auxiliary temperature-control apparatus 152 and the workpiece 102 to be treated.

The arrangement of the auxiliary temperature-control apparatus 152 in the inflow region 158 enlarges the flow cross section compared with an arrangement in the supply duct 142. Furthermore, the auxiliary temperature-control apparatus 152 in the inflow region 158 is more easily accessible for maintenance activities and also no access to the bottom side of the treatment space portion 108 is required.

The use of an auxiliary temperature-control apparatus 152 arranged in this way is advantageous in particular during the first minutes of a treatment space portion 108 provided as heating zone, i.e. for the pre-drying and/or the main drying, since the workpiece 102 to be treated still has an excessively low temperature at the beginning and thus high temperature gradients between the workpiece 102 and the recirculated air prevail.

By way of example, the temperature-control sequence of an auxiliary temperature-control apparatus 152 during the main drying in the context of a cathodic dip coating process is specified below, the so-called baking temperatures in accordance with the specifications of the respective paint supplier for example being 213° C. for at most 15 minutes and 165° C. for at least 15 minutes and the recirculated air temperature for this example being 190° C.:
5 minutes at 230° C.,
2:30 minutes at 205° C., and
2:30 minutes at 200° C.

The auxiliary temperature-control apparatus 152 is preferably electrical, wherein the associated cable terminal board and the individual temperature-control elements 160, which are preferably in the form of heating elements 162, are arranged within the hot region of the treatment space portion 108 and are therefore designed for temperatures up to about 250° C. The associated switchgear cabinet of an auxiliary temperature-control apparatus 152 is arranged in the so-called cold region of a treatment space portion 108 or of a treatment space 107 and comprises a contactor and/or a power controller, such as a thyristor controller. A three-core cable connects the terminal board of the auxiliary temperature-control apparatus 152 to the switchgear cabinet, wherein this connecting cable must also be temperature-stable up to about 250° C.

### List of Reference Signs

100 Treatment plant
102 Workpiece
104 Vehicle body
106 Dryer
107 Treatment space
108 Treatment space portion
110 Housing
112 Conveying apparatus
114 Conveying direction
115 Transverse direction
116 Rail element
117 Air guide system
118 Recirculated air unit
120 Fan
122 Temperature-control apparatus
124 Supply nozzle
126 Supply apparatus
127 Supply module
128 Return duct
130 Distributor space
132 Maintenance region
134 Intake space
136 Ejection region
138 Homogenization region
140 Receiving unit
142 Supply duct
144 Supply portion
146 Nozzle
148 Filter element
150 Bottom wall
152 Auxiliary temperature-control apparatus
154 Temperature sensor
156 Beveled portion
158 Incident-flow region
160 Temperature-control element
162 Heating element

1. A treatment plant for treating workpieces, optionally for drying vehicle bodies, which comprises a treatment space for receiving and treating one or more workpieces, wherein the treatment space includes a plurality of treatment space portions which are each assigned to a separate recirculated air unit by which a recirculated air flow guided through the respective treatment space portion in a flow direction can be generated, wherein the treatment space has a conveying direction through the treatment space portions and a transverse direction of the treatment space running perpendicular to the conveying direction, and wherein each recirculated air unit includes:
a fan for driving the recirculated air flow in the respective recirculated air unit;
one or more temperature-control apparatuses for heating or cooling the recirculated air flow;
one or more supply apparatuses and/or supply modules for supplying the recirculated air flow to the treatment space portion;
one or more supply ducts for supplying the recirculated air flow to the one or more supply apparatuses and/or supply modules; and
one or more return ducts for returning the recirculated air flow from the treatment space portion to the fan.

2. The treatment plant as claimed in claim 1, wherein
a) each recirculated air unit includes one or more electrical auxiliary temperature-control apparatuses for reheating or re-cooling the recirculated air flow in the one or more supply ducts and/or the one or more return ducts;
and/or
b) the one or more temperature-control apparatuses are electrically operated or gas-operated temperature-control apparatuses.

3. The treatment plant as claimed in claim 1, wherein the treatment space includes a conveying apparatus by which one or more workpieces can be conveyed on a receiving unit in the conveying direction through the treatment space portions of the treatment space.

4. The treatment plant as claimed in claim 1, wherein the one or more temperature-control apparatuses are arranged downstream of the fan and upstream of a distributor space, wherein the distributor space adjoins the treatment space and serves to distribute the recirculated air flow to the one or more supply ducts.

5. The treatment plant as claimed in claim 1, wherein an intake space is provided upstream of the fan, wherein
a) the intake space is arranged between the treatment space portion and the fan, optionally in relation to the transverse direction of the treatment space; and/or
b) the intake space is arranged in the vertical direction at least approximately at the same height as an impeller of the fan.

6. The treatment plant as claimed in claim 1, wherein an ejection region and/or a homogenization region are provided downstream of the fan, wherein
a) the ejection region and/or the homogenization region are arranged directly above the fan and/or an intake space; and/or
b) the ejection region and/or the homogenization region are arranged in the horizontal direction at least approximately at the same height as the one or more temperature-control apparatuses.

7. The treatment plant as claimed in claim 1, wherein the fan is a radial fan, wherein an axis of rotation of an impeller of the radial fan is oriented at least approximately horizontally and/or at least approximately perpendicularly to the conveying direction of the treatment space.

8. The treatment plant as claimed in claims 3, wherein at least one supply module within the treatment space portion is arranged
a) below the receiving unit and/or horizontally at least approximately at the same height as the conveying apparatus; or
b) on that side of the treatment space portion which is opposite the fan; or
c) above the one or more workpieces.

9. The treatment plant as claimed in claim 1, wherein a supply module includes one or more supply portions, and in that a supply portion includes in each case at least one nozzle, preferably at least two nozzles.

10. The treatment plant as claimed in claim 9, wherein the one or more supply portions include a plurality of nozzles which are arranged within the respective supply portion parallel and/or transversely to the conveying direction, wherein an incident flow can be applied to in particular sill regions or other high-mass parts of the workpieces by the nozzles.

11. The treatment plant as claimed in claim 9, wherein an arrangement and/or orientation of the at least one nozzle within the respective supply portion can be adapted to the one or more workpieces to be treated, optionally to sill regions or other high-mass parts of the workpieces.

12. The treatment plant as claimed in claim 9, wherein the recirculated air flowing through the nozzles of the supply portions can be supplied directly, optionally unimpeded, to at least part of the one or more workpieces, optionally to sill regions or other high-mass parts of the workpieces.

13. The treatment plant as claimed in claim 1, wherein the one or more return ducts run below the treatment space portion, optionally in a bottom wall which downwardly delimits the respective treatment space portion.

14. The treatment plant as claimed in claim 1, wherein each recirculated air unit includes at least one throttle for retarding the recirculated air flow in certain portions and/or at least one auxiliary fan for accelerating the recirculated air flow in certain portions.

15. The treatment plant as claimed in claim 4, wherein one or more filter elements for filtering the recirculated air are arranged within the distributor space.

16. The treatment plant as claimed in claim 1, wherein the one or more recirculated air units are arranged laterally adjoining the respective treatment space portion and/or are completely accessible at ground level, optionally for assembly and/or maintenance work.

17. A method for treating workpieces, optionally for drying vehicle bodies, the method comprising:
supplying one or more workpieces to a treatment space of a treatment plant, optionally of a treatment plant as claimed in claim 1;
heating or cooling the one or more workpieces by one or more recirculated air flows, wherein the one or more recirculated air flows are generated by one or more recirculated air units.

18. The method as claimed in claim 17, wherein the method further includes:
heating or cooling the one or more recirculated air flows by one or more temperature-control apparatuses and/or one or more auxiliary temperature-control apparatuses, wherein the one or more auxiliary temperature-control apparatuses are preferably arranged in one or more supply ducts of the one or more recirculated air units.

19. The method as claimed in claim 17, wherein conditioned fresh air is supplied to the treatment space and this fresh air is subsequently recirculated as recirculated air flow in one or more recirculated air units, wherein heat is supplied in the recirculated air units exclusively by electrical heating.
